(19) United States
(12) Patent Application Publication
(10) Pub. No.: US 2010/0212461 A1
(43) Pub. Date: Aug. 26, 2010

(54) OPEN END RATCHET WRENCH

(76) Inventor: WILLIAM J. BURT, Gillette, WI (US)

Correspondence Address: James Ray & Associates, 2640 Pitcaim Road, Monroeville, PA, 15146, US

(21) Appl. No.: 12/391,591

(22) Filed: Feb. 24, 2009

(51) Int. Cl. B25B 13/08

(52) U.S. Cl. 81/58.2

(57) ABSTRACT

An open ended ratchet wrench includes an elongated handle and generally C-shaped head that is pivotally connected to the elongated handle. A cavity is formed within the C-shaped head. A pair of dogs pivotally mounted within the cavity, each having ratchet teeth. An elongated spring is positioned within the cavity and heaving each of a first end thereof abuttingly engaging a predetermined portion of one of the pair of dogs and having an opposed second end thereof abuttingly engaging a predetermined portion of an opposed one of the pair of dogs. A generally C-shaped insert is centrally disposed within the head and having ratchet teeth on each dog. An actuating member is secured to the spring and is manually operable to selectively rotate the head with the insert or ratchet the head about the insert.

### FIELD OF THE INVENTION

The present invention relates, in general, to ratchet wrenches and, more particularly, this invention relates to an open end ratchet wrench for manipulating a nut fastener disposed in a continuous line and, yet more particularly, the instant invention relates to a double-reversible open end ratchet wrench for manipulating a nut fastener disposed in a continuous line.

### BACKGROUND OF THE INVENTION

As is generally well known, nut fasteners that are installed in a continuous line are used in a variety of applications including transmission lines for dioxide sensors, oil cooler lines, plumbing, large trucks, water lines, hydraulic lines or refrigerators. Generally, standard open end wrenches are used to manipulate such fastener. However, such standard open end wrenches must be constantly removed from and reapplied to the nut as it is being turned. This condition results in a greater than desirable effort to install or remove the nut.

Prior to the conception and design of the present invention, efforts have been made to alleviate difficulties in manipulating nut fasteners installed in a continuous line. For example, U.S. Pat. No. 3,504,579 issued to Harlan and U.S. Pat. No. 2,456,838 issued to Peterson et al. disclose open end ratchet wrenches that allow for continuous engagement with the nut fastener as it is being turn.

However, there is a continuing need for an improved open end ratchet wrench.

### SUMMARY OF THE INVENTION

The invention provides a ratchet wrench. The ratchet wrench includes an elongated handle defining a longitudinal axis of the ratchet wrench. A head is provided and has a generally C-shaped first portion and an elongated second portion having a proximal end thereof disposed on and secured to an exterior surface of the generally C-shaped first portion. There is means for connecting a distal end of the elongated second portion of the head to one end of the elongated handle. A cavity is formed within an inner edge of the generally C-shaped first portion. A pair of dogs is provided. Each dog has a predetermined plurality of first ratchet teeth disposed an inner surface of the each dog. The dogs are positioned within the cavity of the generally C-shaped first portion of the head so that predetermined pluralities of first ratchet teeth oppose each other relative to the longitudinal axis of the ratchet wrench. There is also means for pivotally connecting each dog to the generally C-shaped first portion of the head. An elongated spring is positioned within the cavity and has each of a first end thereof abuttingly engaging a predetermined portion of one of the pair of dogs and having an opposed second end thereof abuttingly engaging a predetermined portion of an opposed one of the pair of dogs. A generally C-shaped insert is centrally disposed within the C-shaped first portion of the head. The C-shaped insert has each of an inner surface thereof shaped and sized to engage a preselected nut fastener and a predetermined plurality of second ratchet teeth disposed radially on an outer surface thereof and operatively meshing with the predetermined plurality of first ratchet teeth disposed on the inner surface of the each dog. An actuating member is supported on the generally C-shaped first portion and secured to the spring mediate ends thereof. The actuating member is selectively operable to rotate the insert with the ratchet wrench in one rotational direction while ratcheting the ratchet wrench about the insert in an opposed rotational direction and rotate the insert with the ratchet wrench in the opposed rotational direction while ratcheting the ratchet wrench about the insert in the one rotational direction.

### OBJECTS OF THE INVENTION

It is, therefore, one of the primary objects of the present invention to provide an open end ratchet wrench for manipulating a nut fastener disposed in a continuous line.

Another object of the present invention is to provide an open end ratchet wrench that employs a replaceable insert sized and shaped to engage a nut fastener.

Yet another object of the present invention is to provide an open end ratchet wrench that employs a pair of dogs and a bias spring to selectively bias such pair of dogs.

A further object of the present invention is to provide an open end ratchet wrench that employs a wrench head pivotally attached to a wrench handle.

Yet a further object of the present invention is to provide a double-reversible open end ratchet wrench.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

FIG. 1 illustrates a planar view of an open end ratchet wrench constructed in accordance with a presently preferred embodiment of the present invention;

FIG. 2 illustrates a side elevation view of the open end ratchet wrench of FIG. 1;

FIG. 3 illustrates cross-sectional view of the open end ratchet wrench along liens III-III of FIG. 1;

FIG. 4 illustrates cross-sectional view of the open end ratchet wrench along liens IV-IV of FIG. 1;

FIGS. 5a-5b is a cross-sectional view of the open end ratchet wrench along liens V-V of FIG. 2, particularly illustrating operation of the ratcheting arrangement;

FIG. 6 illustrates environmental view of using the open end ratchet wrench of FIG. 1 for tightening and loosing a nut fastener installed in a continuous line;

FIG. 7 a planar view of an open end ratchet wrench constructed in accordance with one alternative embodiment of the present invention; and

FIG. 8 is a planar view of closed end ratchet wrench employing the ratcheting arrangement of an alternative embodiment.

### BRIEF DESCRIPTION OF THE VARIOUS EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

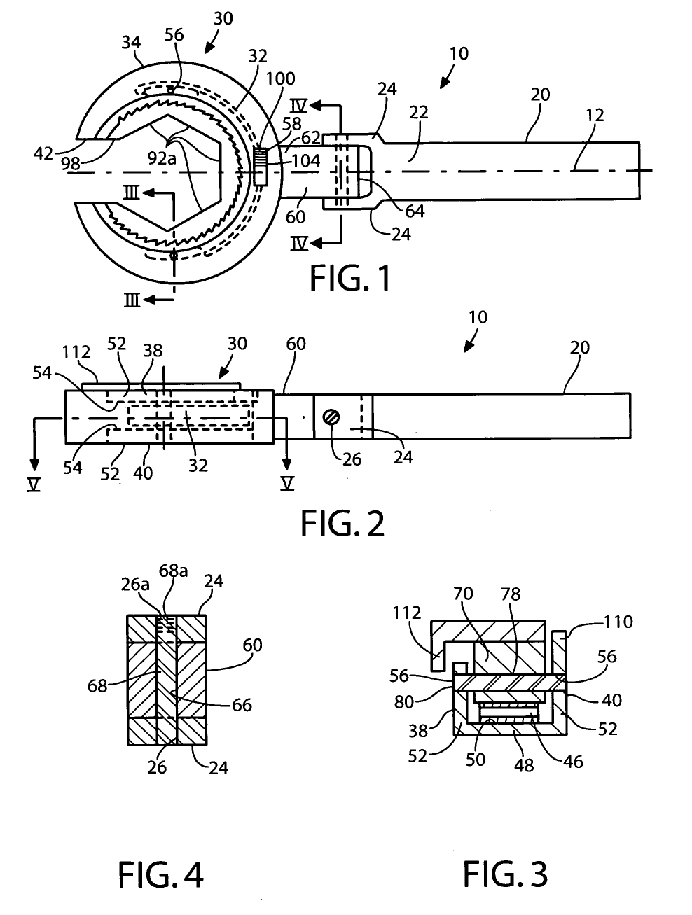

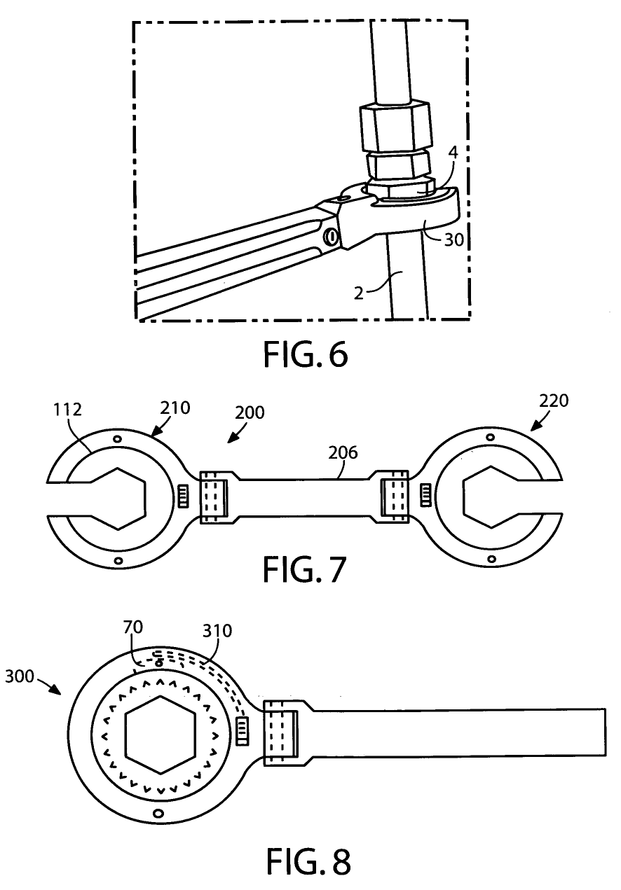

The best mode for carrying out the invention is presented in terms of its presently preferred embodiment, herein depicted within FIGS. 1 through 6 and several alternative embodiments, herein depicted within FIGS. 6-8. However, the invention is not limited to the described embodiments, and a person skilled in the art will appreciate that many other embodiments of the invention are possible without deviating from the basic concept of the invention and that any such work around will also fall under scope of this invention. It is envisioned that other styles and configurations of the present invention can be easily incorporated into the teachings of the present invention, and only several particular configurations shall be shown and described for purposes of clarity and disclosure and not by way of limitation of scope.

Reference is now made, to FIGS. 1-6, wherein there is shown a ratchet wrench, generally designated as 10, for manipulating a nut fastener 4 installed in a continuous line 2 and which is constructed in accordance with a presently preferred embodiment of the invention. The ratchet wrench 10 includes an elongated handle 20 defining a longitudinal axis 12 of the elongated handle 12 and of the ratchet wrench 10. The elongated handle 20 may be manufactured from any conventional material employed in the ratchet wrenches, with metal and, more particularly steel, being a presently preferred material.

The ratchet wrench 10 further comprises a head, generally designated as 30. The head 30 includes a first portion 32. The first portion 32 has a generally annular shape and further has each of a predetermined thickness, an inner edge 33 having a first predetermined radius, an outer edge 34 having a second predetermined outer radius and a pair of substantially flat and parallel outer surfaces 38 and 40. A slot 42 having a predetermined width is formed through a portion of the head 30 to essentially define a C-shaped first portion 32 having an inner space 44 accessible through the slot 42 as well as accessible in either direction transverse to the plane of the C-shaped first portion 32.

A cavity 46 is formed on the inner edge 33 and defines a peripheral wall 48 and a pair of spaced apart walls 52. The peripheral wall 48 has a substantially flat inner surface 50 and carrying thereon the outer edge 34 of the C-shaped first portion 32. Each of the pair of walls 52 has a substantially flat inner surface 54 and also carries thereon a respective outer surface 38, 40 of the C-shaped first portion 32.

For the reasons to be explained later, the C-shaped first portion 32 includes a pair of apertures 56 formed through the pair of walls 52 radially opposing each other relative to the longitudinal axis 12 of the ratchet wrench 10 and in a plane substantially perpendicular to the plane of the C-shaped first portion 32.

There is also a slot 58 which is formed through one of the walls 52 of the C-shaped first portion 32 in open communication with the cavity 46.

The head 30 further includes an elongated second portion 60 generally sized to be received within the bifurcated one end 22 of the handle 20. The elongated second portion 60 has each of a proximal end 62 thereof centrally disposed on and attached to the outer edge 34 of the C-shaped first portion 32 and an axially opposed distal end 64.

The head 30 may be rigidly connected to the handle 20 or formed integral therewith. But, preferably, there is means for pivotally connecting the head 30 to the elongated handle 20. Such pivot means first includes a bifurcated end 22 of the elongated handle 20. The bifurcated end 24 is defined by a pair of legs 24 disposed in parallel and spaced apart relationship to each other. Then, the pivot means includes an aperture 26 that is formed through the bifurcated end 22 substantially transverse to the longitudinal axis 12 and another aperture 66 formed through the elongated second portion 60 of the head 30 adjacent to and spaced from the distal end 64 thereof. The final essential element of the pivot means id a first elongated retaining member 68 that is passed through the apertures 26 and 66 aligned with each other during assembly of the ratchet wrench 10 so that the head 30 is allowed to pivot relative to the elongated handle 20. By way of an example only of FIG. 4, the first elongated retaining member 68 is shown as a fastener having a threaded end 68a threadably engaging a threaded aperture 26a formed in one leg 24 of the bifurcated end 22.

The ratchet wrench 10 also comprises a pair of dogs 70. Each of the pair of dogs 70 has each of a curvilinear inner edge 72, a curvilinear outer edge 74 sized and shaped to compliment an inner surface 50 of the peripheral wall 48 of the C-shaped first portion 32 of the head 30. The curvilinear outer edge 74 is spaced from the inner surface 50 of the peripheral wall 48. A predetermined plurality of first teeth 76 are disposed radially on the inner edge 72 of the each dog 70. There is also an aperture 78 formed through each dog 70. Each 70 is positioned within the cavity 46 so that the aperture 78 is aligned with a respective one of the pair of apertures 56 and so that the predetermined plurality of first teeth 76 protrude into the open inner space 44 of the C-shaped first portion 32.

A pair of second elongated retaining members 80 is also provided, each of the pair of second elongated members 80 is received within each of the aligned apertures 56 and 78, so as to allow pivotal movement of the each dog 70. By way of an example only, such elongated retaining member 80 is illustrated as a simple pin having a diameter slightly larger than the diameter of the apertures 56 and 78 providing for interference fit of the pin 80 therewith.

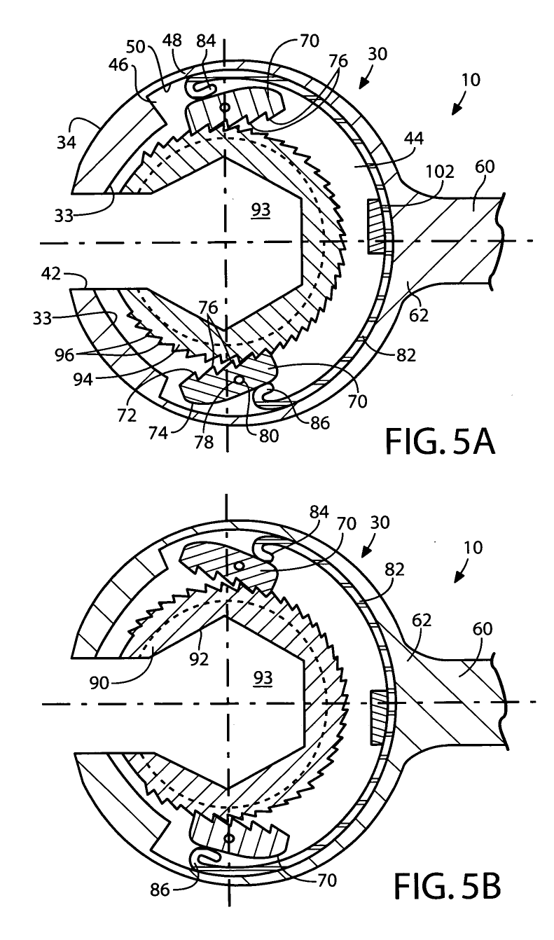

A generally C-shaped spring member 82 is mounted within the cavity 46 so that one distal end 84 of the C-shaped spring member 82 abuts an outer surface 76 of one of the pair of dogs 70 mediate ends thereof and a second distal 86 end of the C-shaped spring member 82 abuts an outer surface 76 of an opposed one of the pair of dogs 70 mediate ends thereof. Each of the pair of ends 84, 86 is enlarged either being rolled onto itself or bent into a generally U-shape as best shown in FIGS. 5a-5b. Such C-shaped spring member 82 is manufactured from tampered steel having resilient characteristics and is generally known in the art as a spring clip.

Another essential element is a generally annular insert 90 having each of an inner edge 92 thereof having each of a predetermined shape and a predetermined size to engage a nut fastener 4. The inner edge 92 essentially defines an inner space 93 of the insert 90. The insert 90 also has a curvilinear outer edge 94, which is substantially round, and a predetermined plurality of second teeth 96 radially formed on the outer edge 94 and operatively meshing with the predetermined plurality of first teeth 76 formed on the inner surface 72 of each dog 70. The insert 90 further includes a slot 98 formed through a portion thereof providing entry into the inner space 93 and essentially providing a C-shaped insert 90.

The final essential element of the present invention is a lever 100 supported on the Generally C-shaped first portion 32 and having each of a first end 102 thereof secured to the generally C-shaped spring member 82 mediate ends thereof and a second end 104 thereof protruding outwardly through the slot 58.

It is presently preferred for the inner edge 92 of the insert 90 to have a quintet of equal flat surface portions 92a and wherein the slot 98 is sized substantially equal to the surface portion 92a so as to essentially form a hexagon shape of the inner edge 92. It will be understood that such hexagon shape is most advantageous to use with a generally hexagon shaped outer surface of the nut fastener 4. However, the present invention also contemplates the employments of other conventional socket shapes.

In operation, the insert 90 is inserted into the inner opening 44 of the C-shaped first portion 32 of the head 30 so as to align the slot 98 with the slot 42. The C-shaped first portion 32 with the insert 90 is then positioned over the line 2 in general alignment with the nut fastener 4 and moved along the line 2 to cage the nut fastener 4 within the inner edge 92.

The lever 100 is manually movable within the slot 58 in one direction to bias each of the pair of dogs 70 so that the C-shaped insert 90 rotates in unison with the C-shaped first portion 32 of the head 30 in a first rotational direction and rotates independently from the C-shaped first portion 32 of the head 30 in an opposed second rotational direction. The lever 100 is manually movable within the slot 58 in an opposed direction to bias each of the pair of dogs 70 so that the C-shaped insert 90 rotates in unison with the C-shaped first portion 32 of the head 30 in the second rotational direction and rotates independently from the C-shaped first portion 32 of the head 30 in the first rotational direction.

In order to facilitate positive retention of the insert 90 within the head 30 during assembly and operation, there is means for supporting the insert 90 positioned within an inner space 35 of the C-shaped first portion 32. It is presently preferred for such support means to be an annular ledge 110 extending inwardly from one wall 52, preferably flush with one of the outer surfaces, shown as the outer surface 40 in FIG. 3. Alternative to or in combination with the annular ledge 110, the insert 90 may be also provided with an annular flange 112 that during assembly abuts one surface 38, 40 of the C-shaped first portion 32.

The operation of the ratchet wrench 10 for tightening the nut fastener 4 is more specifically illustrated in FIG. 5a. The lever 100 is moved in one direction to the top of FIG. 5a, thus rotating the spring member 82 in a counter-clockwise direction. This counter-clockwise direction causes the first end 84 of the spring member 82 to rotate the top dog 70 about its pivot axis provided by the retaining element 80 and bias the teeth 76 disposed on a left end of the top dog 70 for engagement with the teeth 96 of the insert 90. The counter-clockwise direction of the spring member 82 also causes the second end 86 thereof to rotate the bottom dog 70 about its pivot axis provided by the retaining element 80 and bias the teeth 76 disposed on a right end of the left dog 70 for engagement with the teeth 96 of the insert 90. Due to direction of bias forces from the spring member 82, the insert 90 and the head 30 rotate in clockwise direction in unison with each other. More particularly, the fastener 4 is also rotated in the clockwise direction. The head 30 idly rotates independently from the insert 90 and the nut fastener 4 in a counter-clockwise direction thus repositioning the ratchet wrench 10 for a next rotation in clockwise direction wherein the nut fastener 4, the insert 90 and the first portion 32 rotates with each other.

The operation of the ratchet wrench 10 for loosening the nut fastener 4 is more specifically illustrated in FIG. 5b. When the lever 100 is manually moved in an opposed direction or to the bottom of the slot 58 in FIG. 5b, the operation of the ratchet 10 reverses wherein the nut fastener 4, the insert 90 and the first portion 32 rotates with each other in a counter-clockwise direction and wherein the first portion 32 idly rotates independently from the nut fastener 4 and the insert 90 in a clockwise direction. A more detail description of the reversed rotation is omitted for the sake of brevity.

Now in reference to FIG. 7, to accommodate various fastener sizes, a ratchet wrench, generally designated as 200, includes a pair of heads 210 and 220 joined to a common handle 206 either rigidly or pivotally. Each head 210, 220 is constructed in accordance with above described embodiments and sized to accommodate a preselected range of fasteners.

Although the present invention has been shown in terms of the open end ratchet wrench 10, it will be apparent to those skilled in the art, that the present invention may be applied to conventional closed end ratchet wrenches 300, shown in FIG. 8, by essentially providing one dog 70 and a curvilinear spring 310 member which is about half of the spring member 82 of FIGS. 1-6.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

I claim:

1. A ratchet wrench comprising:
(a) an elongated handle defining a longitudinal axis of said ratchet wrench;
(b) a head having a generally C-shaped first portion and an elongated second portion having a proximal end thereof disposed on and secured to an exterior surface of said generally C-shaped first portion;
(c) means for connecting a distal end of said elongated second portion of said head to one end of said elongated handle;
(d) a cavity formed within an inner edge of said generally C-shaped first portion;
(e) a pair of dogs, each of said pair of dogs having a predetermined plurality of first ratchet teeth disposed an inner surface of said each dog, said pair of dogs positioned within said cavity of said generally C-shaped first portion of said head so that predetermined pluralities of first ratchet teeth oppose each other relative to said longitudinal axis of said ratchet wrench;
(f) means for pivotally connecting said each dog to said generally C-shaped first portion of said head;
(g) an elongated spring positioned within said cavity and having each of a first end thereof abuttingly engaging a predetermined portion of one of said pair of dogs and having an opposed second end thereof abuttingly engaging a predetermined portion of an opposed one of said pair of dogs;
(h) a generally C-shaped insert centrally disposed within said C-shaped first portion of said head, said C-shaped insert having each of an inner surface thereof shaped and sized to engage a preselected nut fastener and a predetermined plurality of second ratchet teeth disposed radially on an outer surface thereof and operatively meshing with said predetermined plurality of first ratchet teeth disposed on said inner surface of said each dog; and
(i) an actuating member supported on said generally C-shaped first portion and secured to said spring mediate ends thereof, said actuating member selectively operable to rotate said insert with said ratchet wrench in one rotational direction while ratcheting said ratchet wrench about said insert in an opposed rotational direction and rotate said insert with said ratchet wrench in said opposed rotational direction while ratcheting said ratchet wrench about said insert in said one rotational direction.

2. The ratchet wrench, according to claim 1, wherein said means for connecting a distal end of said elongated second portion of said head to one end of said elongated handle is a pivot means.

3. The ratchet wrench, according to claim 2, wherein said pivot means includes:
(a) a bifurcated end of said elongated handle;
(b) a first aperture formed through each leg of said bifurcated end substantially transverse to said longitudinal axis;
(c) a second aperture formed through said elongated second portion of said head adjacent to and spaced from a distal end thereof, said second aperture is aligned with said first aperture when said elongated second portion is received within said bifurcated end; and
(d) a retaining element received within each of said first and second apertures.

4. The ratchet wrench, according to claim 3, wherein said first aperture disposed in one of said legs is a threaded aperture and wherein said retaining element has a threaded end operatively engaging said threaded aperture.

5. The ratchet wrench, according to claim 1, wherein said generally C-shaped first portion has a curvilinear cavity formed on an inner surface thereof and defining a peripheral wall and a pair of spaced apart end walls upstanding on said peripheral wall.

6. The ratchet wrench, according to claim 5, wherein said means for pivotally connecting said each dog to said generally C-shaped first portion of said head includes:
(a) a pair of apertures formed through said pair of end walls radially opposing each other relative to said longitudinal axis of said ratchet wrench and in a plane substantially perpendicular thereto;
(b) an aperture formed through said each dog and aligned with a respective one of said pair of apertures when said pair of dogs are positioned within said generally C-shaped first portion of said head; and
(c) an elongated retaining member frictionally received in each of said pair of apertures formed through said pair of end walls and said aperture formed through said each dog.

7. The ratchet wrench, according to claim 1, wherein said actuating member is a lever having one end thereof rigidly connect to said spring and wherein said generally C-shaped first portion of said head includes a slot formed through one end wall thereof and sized to receive an opposed end of said lever.

8. The ratchet wrench, according to claim 1, wherein said ratchet wrench includes means for supporting said insert positioned within said generally C-shaped first portion.

9. The ratchet wrench, according to claim 8, wherein said supporting means is a peripheral ledge extending a predetermined distance into said generally C-shaped first portion.

10. The ratchet wrench, according to claim 8, wherein said supporting means is a peripheral ledge dispose don said generally C-shaped insert

11. A ratchet wrench comprising:
(a) an elongated handle defining a longitudinal axis of said ratchet wrench and having each of a bifurcated one end and a first aperture formed through said bifurcated one end substantially transverse to said longitudinal axis;
(b) a head including:
(i) a generally C-shaped first portion having each of an inner surface and an outer surface,
(ii) a curvilinear cavity formed on said inner surface and defining a peripheral wall and a pair of spaced apart end walls upstanding on said peripheral wall,
(iii) a pair of second apertures formed through said pair of end walls radially opposing each other relative to said longitudinal axis of said ratchet wrench and in a plane substantially perpendicular thereto,
(iv) a slot formed through one of said end wall in open communication with said curvilinear cavity,
(v) an elongated second portion sized to be received within said bifurcated one end of said handle and having each of a proximal end thereof centrally disposed on and attached to said outer surface of said generally C-shaped first portion and an axially opposed distal end,
(vi) a third aperture formed through said elongated second portion of said head adjacent to and spaced from said distal end thereof;
(c) a first elongated member passed through said first aperture and through said third aperture when said third aperture is aligned with said first aperture so that said head is allowed to pivot relative to said elongated handle;
(d) a pair of dogs, each of said pair of dogs having each of a curvilinear inner surface, curvilinear outer surface sized and shaped to compliment an inner surface of said peripheral wall of said generally C-shaped first portion of said head, a predetermined plurality of first teeth radially disposed on said inner surface of said each dog and a forth aperture formed through said each dog, said pair of dogs positioned within said cavity so that said forth aperture is aligned with a respective one of said pair of second apertures and so that said predetermined plurality of first teeth are angled toward elongated second portion of said head;
(e) a pair of second elongated members, each of said pair of second elongated members received within each of said aligned second aperture and said forth aperture so as to allow pivotal movement of said each dog;
(f) an elongated spring member mounted within said cavity so that one distal end of said elongated spring member abuts an outer surface of one of said pair of dogs mediate ends thereof and a second distal end of said elongated spring member abuts an outer surface of an opposed one of said pair of dogs mediate ends thereof;
(g) a generally C-shaped insert having each of an inner surface thereof having each of a predetermined shape and a predetermined size to engage a nut fastener, a curvilinear outer surface, a predetermined plurality of second teeth formed on said curvilinear outer surface of said generally C-shaped insert and operatively meshing with said predetermined plurality of first teeth formed on said inner surface of said each dog; and
(h) a lever having each of a first end thereof secured to said generally elongated spring member mediate ends thereof and a second end thereof protruding outwardly through said slot formed through said one of said end wall, whereby said lever manually movable within said slot in one direction to bias said each of said pair of dogs so that said generally C-shaped insert rotates in unison with said C-shaped first portion of said head in a first rotational direction and rotates independently from said C-shaped first portion of said head in an opposed second rotational direction, and whereby said lever manually movable within said slot in an opposed direction to bias said each of said pair of dogs so that said generally C-shaped insert rotates in unison with said generally C-shaped first portion of said head in said second rotational direction and rotates independently from said generally C-shaped first portion of said head in said first rotational direction.

12. The ratchet wrench according to claim 11, wherein said ratchet wrench includes a second head attached to an opposed second end of said elongated handle.

13. The ratchet wrench according to claim 11, wherein said ratchet wrench includes each of an opposed second bifurcated end of said elongated handle and a second head pivotally attached to said opposed second bifurcated end.

14. A ratchet wrench comprising:
(a) an elongated handle defining a longitudinal axis of said ratchet wrench;
(b) a head having a generally annular first portion and an elongated second portion having a proximal end thereof disposed on and secured to an exterior surface of said generally annular first portion;
(c) mans for connecting a distal end of said elongated second portion of said head to one end of said elongated handle;
(d) a cavity formed in said first portion of said head;
(e) a dog having a predetermined plurality of first ratchet teeth disposed an inner surface thereof, said dog positioned within said cavity of said generally annular first portion of said head so that predetermined pluralities of first ratchet teeth oppose each other relative to said longitudinal axis of said ratchet wrench;
(f) means for pivotally connecting said dog to said generally annular first portion of said head;
(g) an elongated spring disposed within said cavity and having a first end thereof abuttingly engaging an outer surface of said dog;
(h) an annular insert centrally disposed within said annular first portion of said head, said annular insert having each of an inner surface thereof shaped and sized to engage a preselected nut fastener and a predetermined plurality of second ratchet teeth disposed radially on an outer surface thereof and operatively meshing with said predetermined plurality of first ratchet teeth disposed on said inner surface of said each dog; and
(i) an actuating member supported on said generally annular first portion and secured to an opposed second end of said spring, said actuating member selectively operable to rotate said insert with said ratchet wrench in one rotational direction while ratcheting said ratchet wrench about said insert in an opposed rotational direction and rotate said insert with said ratchet wrench in said opposed rotational direction while ratcheting said ratchet wrench about said insert in said one rotational direction.
